(19) United States
(12) Patent Application Publication
(10) Pub. No.: US 2026/0077530 A1
(43) Pub. Date: Mar. 19, 2026

(54) CUTTING HEADS, CUTTING MACHINES EQUIPPED THEREWITH, AND METHODS OF OPERATION

(71) Applicant: Urschel Laboratories, Inc., Chesterton, IN (US)

(72) Inventor: Dustin Joseph Gereg, Valparaiso, IN (US)

(21) Appl. No.: 18/888,695

(22) Filed: Sep. 18, 2024

(51) Int. Cl. B26D 7/26; B26D 7/06

(52) U.S. Cl. CPC B26D 7/2628; B26D 7/0691; B26D 7/2614; B26D 2210/02

(57) ABSTRACT

Cutting heads, machines equipped therewith, and adjustment units for adjusting components of such machines to produce products having a desired thickness. The cutting head includes a slicing unit and an adjustable gate that are mounted with a pair of mounting blocks. The gate defines a gate opening with a cutting edge of a knife of the slicing unit. An adjustment unit includes an adjustment screw disposed in a bore of a housing and threadably received in a threaded bore in one of the mounting blocks, an indicator and spring disposed in the bore, and a scale along a perimeter of the indicator. The adjustment screw and indicator have complementary splines, and the spring is arranged within the bore so that the splines of the adjustment screw and indicator are engaged with each other under a biasing influence of the spring and can disengage each other by compressing the spring.

### BACKGROUND OF THE INVENTION

The present invention generally relates to machines for cutting products, including but not limited to slicing, strip cutting, shredding, and/or granulating food products. The invention particularly relates to adjustment units for adjusting components of a cutting machine to achieve desired products, as a nonlimiting example, food products having a desired thickness.

Various types of equipment are known for slicing, shredding and granulating food products, as nonlimiting examples, vegetables, fruits, dairy products, and meat products. Widely used machines for this purpose are commercially available from Urschel Laboratories, Inc., and include machines under the name Model CC7. The Model CC7 machines are centrifugal-type slicers capable of slicing a wide variety of products at high production capacities. The Model CC7 line of machines is particularly adapted to produce uniform slices, strip cuts, shreds, and granulations. Certain configurations and aspects of Model CC7 machines are represented in U.S. Pat. Nos. 3,139,128, 3,139,129, 5,694,824, 6,968,765, 7,658,133, 8,161,856, 9,193,086, 10,456,943, 10,562,203, 10,632,639, 10,780,602, 10,786,922, 10,807,268, 10,933,552, 11,034,043, 11,298,849, 12,083,699, and 12,097,634, and U.S. Patent Application Publication Nos. 2022/0332004 and 2023/0202067, the entire contents of which are incorporated herein by reference.

FIG. 1 schematically represents a cross-sectional view of a machine 10 that is representative of a Model CC7 machine. The machine 10 includes a generally annular-shaped cutting head 12 and an impeller 14 coaxially mounted within the cutting head 12. The impeller 14 has an axis 17 of rotation that coincides with the center axis of the cutting head 12, and is rotationally driven about its axis 17 through a shaft (not shown) that is enclosed within a housing 18 and coupled to a gear box 16. The cutting head 12 is mounted on a support ring 15 above the gear box 16 and remains stationary as the impeller 14 rotates. Products are delivered to the cutting head 12 and impeller 14 through a feed hopper 11 located above the impeller 14. In operation, as the hopper 11 delivers products to the impeller 14, centrifugal forces cause the products to move outward into engagement with cutting knives (not shown) that are mounted along the circumference of the cutting head 12. The impeller 14 comprises generally radially oriented paddles 13, each having a face that engages and directs the products radially outward toward and against the knives of the cutting head 12 as the impeller 14 rotates. Other aspects pertaining to the construction and operation of Model CC7 machines, including various embodiments thereof, can be appreciated from the aforementioned prior patent documents incorporated herein by reference.

FIGS. 2 and 3 contain isolated views of an embodiment of a cutting head 12 that is capable of use with a variety of cutting machines, including the Model CC slicing machine 10 represented in FIG. 1. The cutting head 12 represented in FIGS. 2 and 3 will be described hereinafter in reference to the slicing machine 10 of FIG. 1 equipped with an impeller 14 as described in reference to FIG. 1. On the basis of the coaxial arrangement of the cutting head 12 and the impeller 14, relative terms including but not limited to Aaxial, @Acircumferential, @Aradial, @ etc., and related forms thereof may be used below to describe the cutting head 12 represented in FIGS. 2 and 3.

In the isolated view of FIG. 2, the cutting head 12 can be seen to be generally annular-shaped with cutting knives 20 mounted at its perimeter. FIGS. 2 and 3 represent the knives 20 as having straight cutting edges for producing flat slices, and as such may be referred to herein as Aflat@ knives, though the cutting head 12 can use knives of other shapes, for example, Acorrugated@ knives characterized by a periodic pattern, such as a sinusoidal shape with peaks and valleys when viewed edgewise, to produce “wavy” or “corrugated” slices. Such knives can be modified or provided with accessories so that such flat and wavy slices can be further reduced in size to produce strip-cut, shredded, or granulated products. Each knife 20 projects radially inward in a direction generally opposite the direction of rotation of the impeller 14 within the cutting head 12, and defines a cutting edge at its radially innermost extremity. The cutting head 12 further comprises lower and upper support rings 22 and ring 24 to and between which circumferentially-spaced slicing units 26 are mounted, each defining a cutting station of the cutting head 12. The knives 20 of the cutting head 12 are individually secured with clamping assemblies 28 to the slicing units 26. In the particular configuration shown in FIG. 2, each knife 20 has a handle 56 at its upper longitudinal end that protrudes through an opening 57 in the upper support ring 24.

As more readily evident in FIG. 3, the clamping assembly 28 of each slicing unit 26 includes a knife holder 30 mounted with fasteners 32 to and between a pair of mounting blocks 34, which in turn are configured to be secured to the support rings 22 and 24 with fasteners 36 that rigidly secure the mounting blocks 34 to the rings 22 and 24. Each clamping assembly 28 further includes a clamp 31 positioned on the radially outward-facing side of the holder 30 to secure a knife 20 thereto. As shown in FIG. 3, the knife 20 is supported by a radially outer surface of the knife holder 30, and the clamp 31 overlies the holder 30 so that the knife 20 is between the surface of the holder 30 and a radially inward surface of the clamp 31 that faces the holder 30. Alignment of the knife 20, holder 30, and clamp 31 is achieved with pins 48 that protrude from the knife holder 30 into complementary slots and holes in, respectively, the knife 20 and clamp 31. By forcing the clamp 31 toward the holder 30, the clamp 31 will apply a clamping force to the knife 20 adjacent its cutting edge.

As shown in FIG. 3, an eccentric cam rod 50 can be used as a quick-clamping feature to apply the clamping force to the clamp 31. The cam rod 50 is represented as passing through holes in the mounting blocks 34 to loosely assemble the clamp 31 to the mounting blocks 34 in combination with the pivot axis of the clamp 31 created by the fasteners 36. Clockwise rotation of the cam rod 50 (as viewed in FIG. 3) using a handle 58 attached thereto causes the cam rod 50 to eccentrically move into engagement with the surface of the clamp 31, forcing the clamp 31 into engagement with the knife 20. The force applied to the clamp 31 by the cam rod 50 can be released by rotating the cam rod 50 counterclockwise. Once the clamping forced is released, a knife 20 can be removed from the cutting head 12 by grasping its handle 56 and withdrawing the knife 20 upward through the opening 57 in the upper support ring 24.

The clamp 31 is pivotably mounted to the mounting blocks 34, and in the embodiment shown the fasteners 36 that secure the mounting blocks 34 to the rings 22 and 24 may extend through the blocks 34 to also serve as pivot pins for the clamp 31. The mounting blocks 34 are equipped with pins 38 that engage holes in the support rings 22 and 24. By appropriately locating the holes in the rings 22 and 24, the orientation of the mounting blocks 34, and consequently the knife 20, knife holder 30, and clamp 31 mounted thereto, can be used to alter the radial location of the cutting edge of the knife 20 with respect to the axis of the cutting head 12, thereby providing relatively coarse control of the thickness of the sliced food product.

FIGS. 2 and 3 further show each slicing unit 26 as comprising an adjustable gate 40 secured to the mounting blocks 34 with fasteners 42. A food product crosses the gate 40 prior to encountering the knife 20 mounted to the succeeding slicing unit 26, and together the cutting edge of a knife 20 and a preceding trailing edge 46 of the preceding gate 40 define a gate opening that determines the thickness of a slice produced by the knife 20 (as well as the thickness of any strip-cut, shredded, or granulated product produced from the slice). To provide relatively fine control of the thickness of a sliced product, each mounting block 34 is equipped with an adjustment screw 44 that engages the gate 40 mounted thereto to alter the radial location of the trailing edge 46 of the gate 40 relative to the cutting edge of the succeeding knife 20 by adjusting the extent to which the trailing edge 46 is deflected in radially inward and outward directions of the cutting head 12 and thereby relative to the cutting edge of the knife 20.

As disclosed in some of the aforementioned prior patent documents incorporated herein by reference, an alternative to the quick-clamping arrangement of FIGS. 2 and 3 is to employ bolts to secure the knives 20 and clamps 31 to their respective knife holders 30.

While centrifugal-type slicers of the type represented by the Model CC7 have performed extremely well for their intended purpose, further improvements are continuously desired and sought.

### BRIEF DESCRIPTION OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, cutting heads and machines equipped therewith for cutting products, including but not limited to slicing, strip cutting, shredding, and/or granulating food products, and to adjustment units for adjusting components of such machines to produce products having a desired thickness.

According to a nonlimiting aspect of the invention, a cutting head of a cutting machine is provided that includes a pair of mounting blocks spaced apart from each other and a slicing unit and an adjustable gate mounted with the pair of mounting blocks. The slicing unit includes a knife having a cutting edge configured to produce product slices, and the adjustable gate defines a gate opening between the cutting edge of the knife and a trailing edge of the adjustable gate. The adjustable gate is adjustable by moving the trailing edge thereof relative to the cutting edge. The cutting head is further provided with an adjustment unit that includes a housing, an adjustment screw disposed in a bore of the housing and threadably received in a threaded bore in a first mounting block of the pair of mounting blocks, a spring disposed in the bore of the housing, an indicator disposed in the bore of the housing and surrounding a head of the adjustment screw, and a scale along a perimeter of the indicator. The adjustment screw has splines and the indicator has splines that are complementary to each other. The spring is arranged within the bore of the housing so that the splines of the adjustment screw and the splines of the indicator are engaged with each other under a biasing influence of the spring and the splines of the indicator disengage from the splines of the adjustment screw by compressing the spring.

According to another nonlimiting aspect of the invention, a cutting machine is provided in which an annular-shaped cutting head as described above is installed. The cutting machine includes an impeller coaxially mounted within the cutting head for rotation about an axis of the cutting head in a rotational direction relative to the cutting head.

Other aspects of the invention include methods of adjusting a cutting head as described above by rotating the adjustment screw to deflect the trailing edge of the adjustable gate relative to the cutting edge of the knife. With an adjustment unit as described above, rotating the adjustment screw to adjust the gate opening causes the indicator to rotate in unison with the adjustment screw as a result of the splines of the indicator being engaged with the splines of the adjustment screw, and rotating the indicator aligns an indicator mark of the indicator with a calibration mark of the scale. Alternatively or in addition, compressing the spring to disengage the splines of the indicator from the splines of the adjustment screw allows the indicator to be independently rotated relative to the adjustment screw to align the indicator mark with a second calibration mark of the scale.

Technical aspects of machines described above preferably include the ability to utilize adjustment units that can facilitate adjustments that control of thicknesses of products produced with such machines without the use of a separate tool for measuring the gate opening.

Other aspects and advantages of this invention will be appreciated from the following detailed description.

### BRIEF DESCRIPTION OF THE DRAWINGS

FIG. 1 schematically represents a side view in partial cross-section of a centrifugal-type slicing machine known in the art.

FIG. 2 is a perspective view representing a nonlimiting example of a cutting head capable for use with the slicing machine of FIG. 1.

FIG. 3 is a detailed view showing a fragment of the cutting head of FIG. 2.

FIGS. 4 and 5 are detailed views of a fragment of a cutting head, such as of a type represented in FIGS. 2 and 3, and shows an adjustment unit installed on a mounting block of the cutting head.

FIG. 6 is a cross-sectional view of the adjustment unit of FIGS. 4 and 5 and depicts the adjustment unit as including housing, an adjustment screw, an indicator, a locking tab, and a spring.

FIG. 7 is an isolated perspective view showing the adjustment screw threaded into the mounting block, with other components of the adjustment unit of FIGS. 4 through 6 omitted for purposes of illustration.

FIG. 8 is an isolated perspective view similar to FIG. 7, but additionally showing the spring and locking tab secured to the mounting block with the adjustment screw. The indicator and housing of the adjustment unit are omitted for purposes of illustration.

FIG. 9 is an isolated perspective view of the locking tab of the adjustment unit of FIGS. 4 through 6.

FIG. 10 is an isolated perspective view similar to FIG. 8, but additionally showing the indicator secured to the mounting block with the adjustment screw. The housing of the adjustment unit is omitted for purposes of illustration.

FIG. 11 is an isolated perspective view of the indicator of the adjustment unit of FIGS. 4 through 6.

FIG. 12 is an isolated perspective view of the housing of the adjustment unit of FIGS. 4 through 6.

FIG. 13 is a detail of the cross-sectional view of FIG. 6, and shows the spring in a partially compressed state that causes both the locking tab and the indicator to engage the adjustment screw, whereby the adjustment screw is in a locked rotational position with the locking tab and the indicator is in a locked rotational position with the adjustment screw.

FIG. 14 is a detailed cross-sectional view similar to FIG. 13, but showing the spring sufficiently compressed a first extent to disengage the locking tab from the adjustment screw while the indicator remains engaged with the adjustment screw, whereby the adjustment screw is able to be rotated from the locked rotational position of FIG. 13 and the indicator rotates in unison with the adjustment screw.

FIG. 15 is a detailed cross-sectional view similar to FIGS. 13 and 14, but showing the spring sufficiently compressed a second extent (greater than the first extent of FIG. 14) to disengage both the locking tab and the indicator from the adjustment screw, whereby the adjustment screw is able to be rotated from the locked rotational position of FIG. 13 and the indicator is able to be rotated independently of the adjustment screw.

### DETAILED DESCRIPTION OF THE INVENTION

The intended purpose of the following detailed description of the invention and the phraseology and terminology employed therein is to describe what is shown in the drawings, which include the depiction of one or more nonlimiting embodiments of the invention, and to describe certain but not all aspects of what is depicted in the drawings. The following detailed description also identifies certain but not all alternatives of the embodiment(s) depicted in the drawings. As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

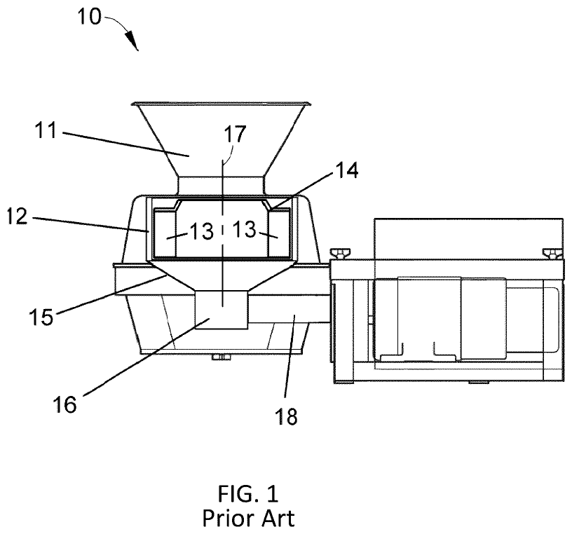

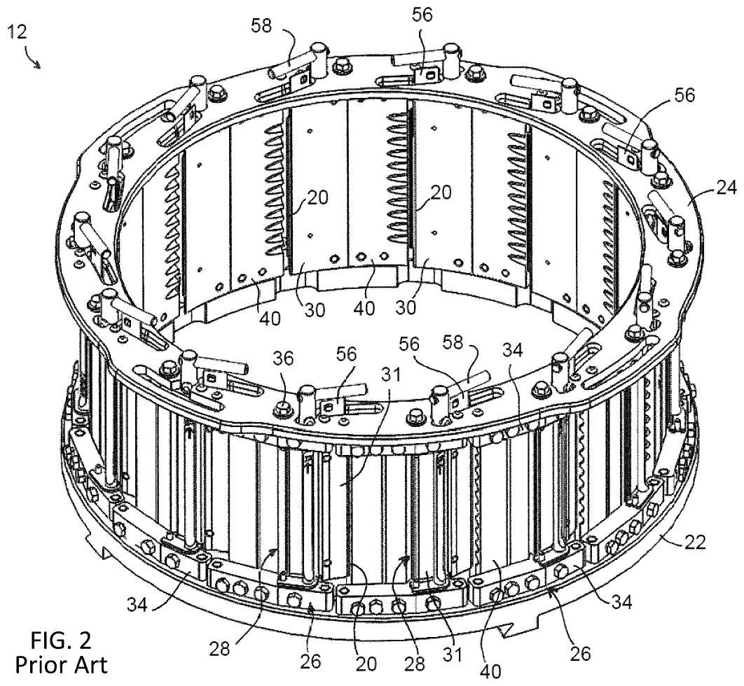

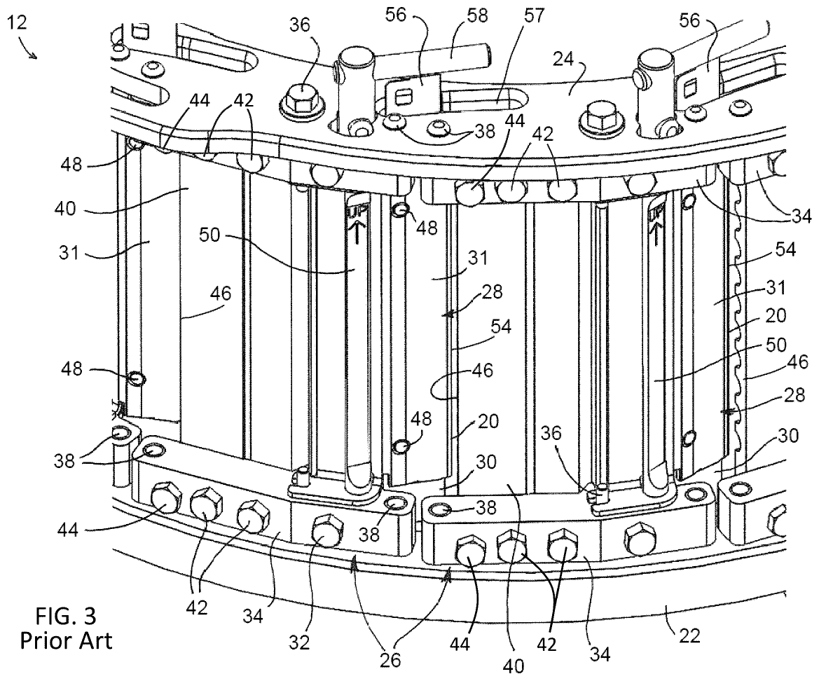

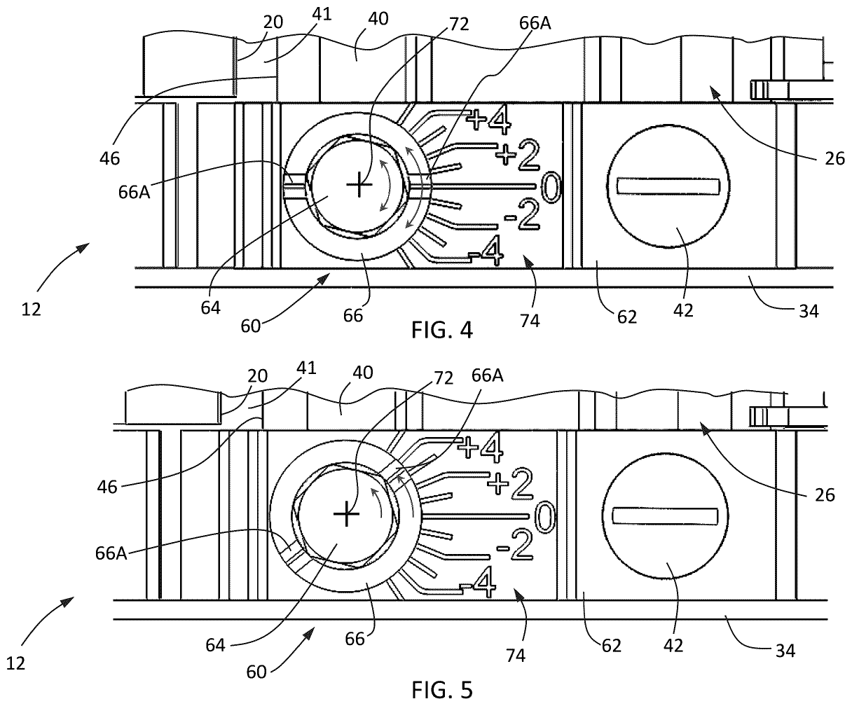

FIGS. 4 through 15 schematically represent a nonlimiting embodiment of an adjustment unit 60 that is capable of use with a variety of cutting machines, including but not limited to the centrifugal-type slicing machine 10 depicted in FIG. 1 and the cutting head 12 depicted in FIGS. 2 and 3. In some instances, the adjustment unit 60 disclosed herein may serve as modification to machines and cutting heads of the type represented in FIGS. 1 through 3. As a matter of convenience, the adjustment unit 60 will be illustrated and described hereinafter in reference to the slicing machine 10 of FIG. 1 equipped with an annular-shaped cutting head 12 as described in reference to FIGS. 2 and 3. As such, the following discussion will focus primarily on certain aspects of the adjustment unit 60 that will be described in reference to certain aspects of the machine 10 and cutting head 12 represented in FIGS. 1 through 3, whereas other aspects of the machine 10 and cutting head 12 not discussed in any detail below may be essentially as was described in reference to FIGS. 1 through 3. However, it will be appreciated that the teachings of the invention are also generally applicable to other types of cutting machines. Moreover, though such machines and cutting heads are particularly well suited for slicing food products, it is within the scope of the invention that the adjustment unit 60 described herein could be utilized in machines and cutting heads adapted to cut a wide variety of other types of materials.

To facilitate the description provided below of the adjustment unit 60 represented in the drawings, relative terms, including but not limited to, Avertical, @Ahorizontal, @Alateral, @Afront, @Arear, @Aside, @Aforward, @Arearward, @Aupper, @Alower, @Aabove, @Abelow, @Aright, @Aleft, @ etc., may be used herein in reference to the orientation of the adjustment unit 60 relative to the cutting head 12 of FIG. 2, as represented by the cutting head 12 and impeller 14 of the machine 10 represented in FIG. 1. On the basis of the coaxial arrangement of the cutting head 12 and impeller 14 in FIG. 1, relative terms including but not limited to Aaxial, @Acircumferential, @Aradial, @ etc., and related forms thereof may also be used herein to describe the nonlimiting embodiments represented in the drawings. All such relative terms are useful to describe the adjustment unit 60 depicted in FIGS. 4 through 15, but should not be otherwise interpreted as limiting the scope of the invention. Furthermore, as used herein, “leading” (and related forms thereof) refers to a position or direction on the cutting head 12 that is ahead of or precedes another in the direction of rotation of the impeller 14 when assembled with and rotating within a cutting head 12, whereas “trailing” (and related forms thereof) refers to a position or direction on the cutting head 12 that follows or succeeds another relative to the direction of rotation of the impeller 14.

For convenience, consistent reference numbers are used throughout FIGS. 4 through 15 to identify the same or functionally related/equivalent elements of the adjustment unit 60 represented in the drawings.

With reference to FIGS. 4, 5, and 6, the adjustment unit 60 is represented as mounted to one of the mounting blocks 34 of the cutting head 12 of FIGS. 2 and 3. As described in reference to FIGS. 2 and 3, the mounting block 34 is preferably one of two mounting blocks 34 that are spaced apart from each other and by which an individual slicing unit 26 and an adjustable gate 40 thereof can be mounted, for example, to the support rings 22 and 24 of the cutting head 12 shown in FIG. 2. The term “mounting blocks” is used herein to describe any structure that is capable of mounting a slicing unit and adjustable gate of a cutting machine, which foreseeably could be the rings 22 and 24 themselves, and therefore the term is not necessarily intended to be limited to the mounting blocks 34 represented in FIGS. 2 and 3.

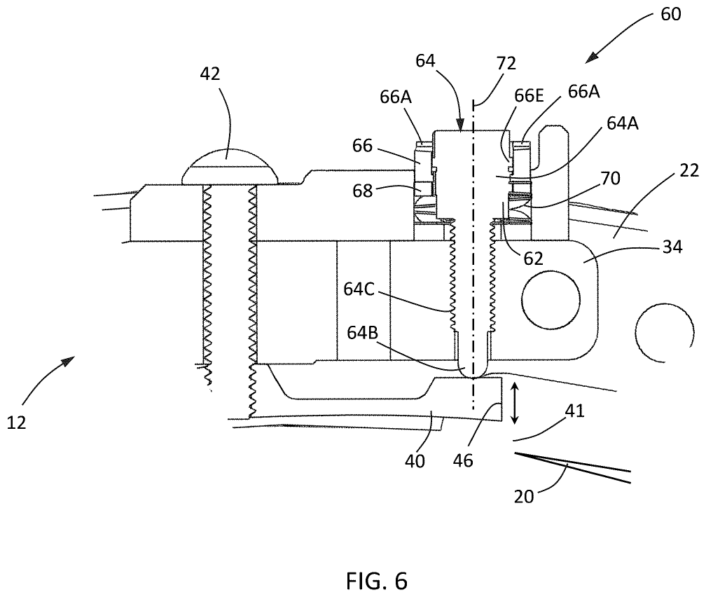

As in FIGS. 2 and 3, the adjustable gate 40 is represented in FIGS. 4 through 6 as secured to the mounting block 34 with at least one fastener 42, and the gate 40 is in a leading position relative to a knife 20 of the slicing unit 26 so that a product crosses the gate 40 prior to encountering a cutting edge of the knife 20, such that together the cutting edge of the knife 20 and a trailing edge 46 of the gate 40 define a gate opening 41 that determines the thickness of a slice produced by the knife 20 (the term “slice” will be used herein, though it should be understood that the thickness thereof also applies to the thickness of a strip-cut, shredded, or granulated product produced from the slice). As with the gate 40 depicted in FIGS. 2 and 3, the gate opening 41 can be adjusted by moving the trailing edge 46 of the gate 40 relative to the cutting edge of the knife 20, as indicated by arrows in FIG. 6. The gate opening 41 is preferably intended to be adjusted by forcibly deflecting the trailing edge 46 of the gate 40, as opposed to pivoting the entire gate 40 or the entire slicing unit 26 relative to the mounting blocks 34.

Whereas the mounting blocks 34 depicted in FIGS. 2 and 3 are equipped with adjustment screws 44 that engage the gates 40 to alter the locations of their trailing edges 46 relative to the cutting edges of their succeeding knives 20, from the following discussion it will be apparent that the adjustment unit 60 can be used in lieu of any one or more of the adjustment screws 44 of FIGS. 2 and 3 to provide control of the thickness of a sliced product. It should be noted that, though a single mounting block 34 is visible in FIGS. 4 through 6, in preferred embodiments each mounting block 34 of FIGS. 2 and 3 could have a similar adjustment unit 60 mounted thereto to alter the location of the trailing edge 46 of each gate 40, as similarly described for the adjustment screws 44 discussed in reference to FIG. 3. Other aspects of the mounting block 34, slicing unit 26, and gate 40 may be as described in reference to FIGS. 2 and 3.

FIGS. 4 through 6 depict the adjustment unit 60 as comprising a housing 62, an adjustment screw 64, and an indicator 66, and FIG. 6 further depicts the adjustment unit 60 as comprising a locking tab 68 and a spring 70. The housing 62 is represented as secured to the mounting block 34 at least in part by one of the fasteners 42 that secure the gate 40 to the mounting block 34, though other means for incorporating the housing 62 into the mounting block 34 are foreseeable, including the housing 62 being formed as an integral feature of the block 34. The adjustment screw 64 is seen in FIG. 6 as threaded through the mounting block 34, such that a head 64A of the screw 64 is accessible from a radially outward side of the cutting head 12, a distal end 64B of the screw 64 bears against a radially outward side of the gate 40 adjacent its trailing edge 46, and a threaded shank 64C of the screw 64 is threadably received in a threaded bore within the mounting block 34. In this arrangement, rotation of the screw 64 causes the trailing edge 46 of the gate 40 to move radially inward and outward relative to the axis 17 of the cutting head 12 and impeller 14 (see FIG. 1), resulting in the production of slices of, respectively, lesser and greater thicknesses. The gate 40 is preferably mounted to the mounting blocks 34 so as to be biased in a radially outward direction relative to the cutting head 12, such that rotation of the screw 64 causes the trailing edge 46 of the gate 40 to move radially inward and radially outward, e.g., if the shank 64C has righthand threads, rotating the screw 64 clockwise causes the distal end 64B to force the trailing edge 46 to move radially inward (to yield relatively thinner slices) and rotating the screw 64 counterclockwise allows the trailing edge 46 to move radially outward (to yield relatively thicker slices). It is also foreseeable that the distal end 64B of the screw 64 could be coupled to the gate 40 so as to be able to move the trailing edge 46 inward and outward without biasing the gate 40.

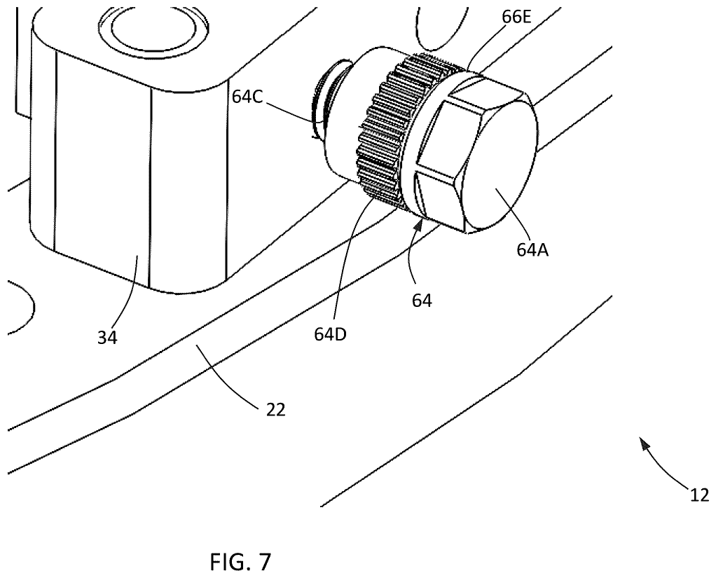

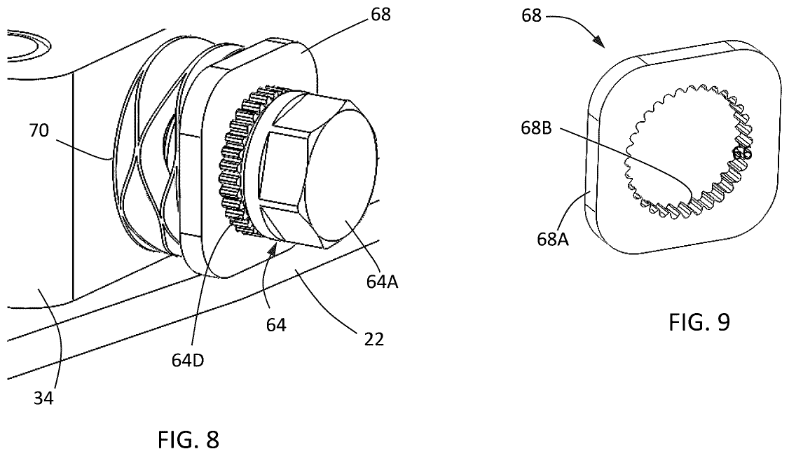

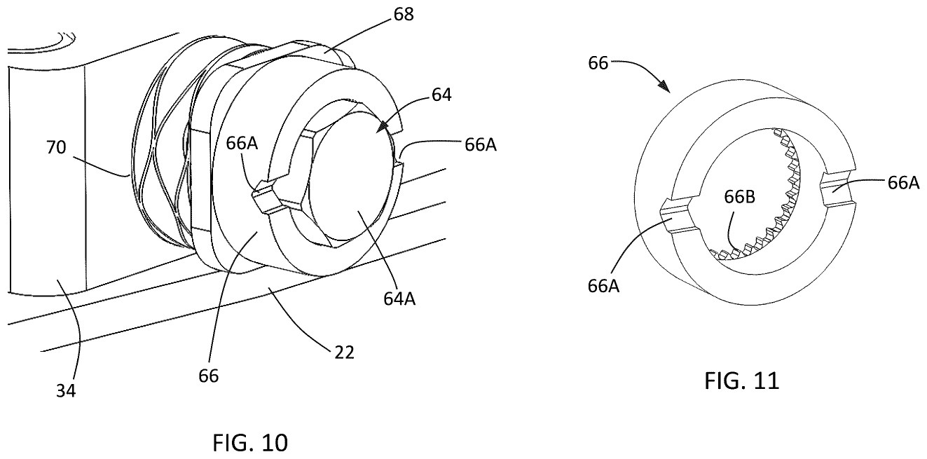

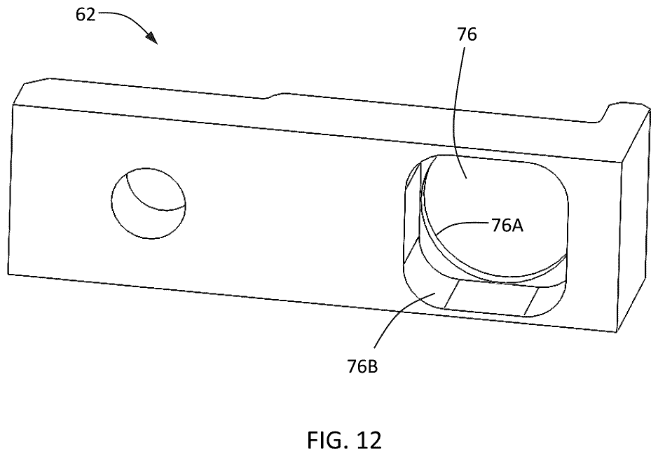

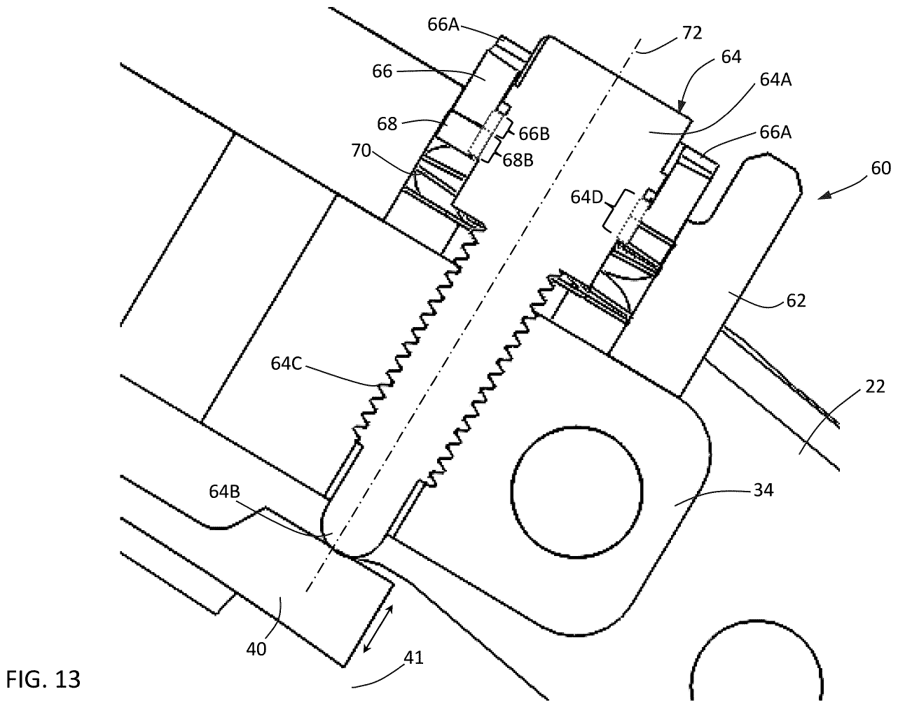

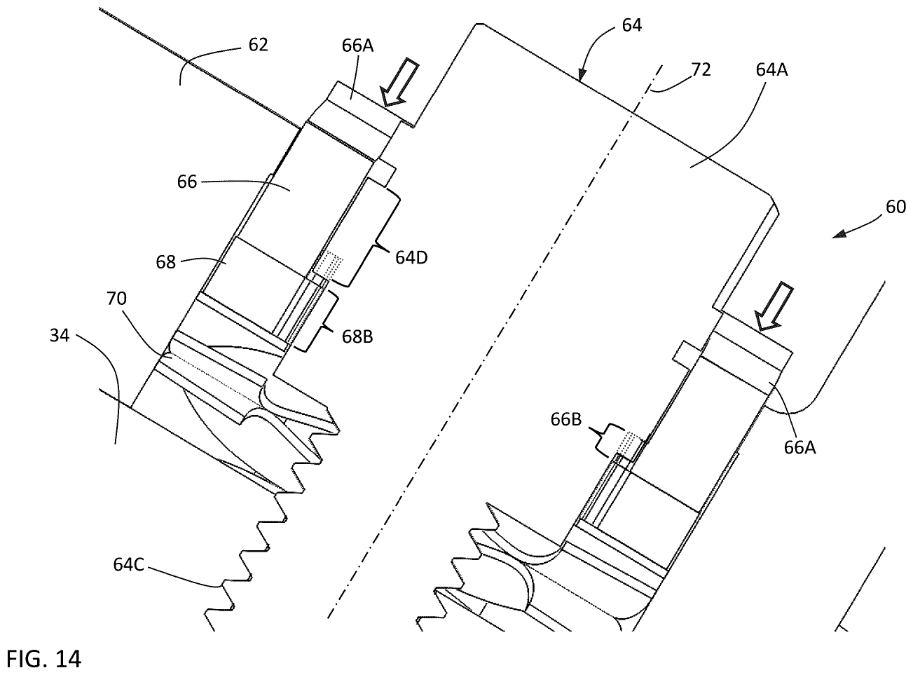

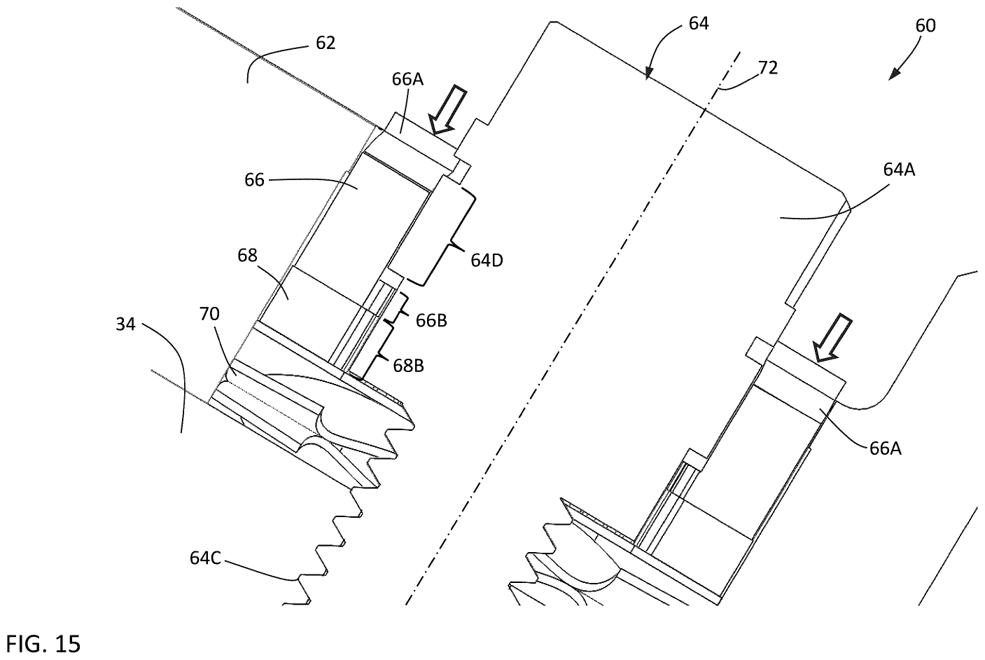

As shown in FIG. 6, the indicator 66, locking tab 68, and spring 70 are retained on the housing 62 by the adjustment screw 64, for example, with a flange 64E, each surrounding the head 64A of the screw 64 so that at least the screw 64 and indicator 66 share a common axis 72 of rotation, which also preferably defines a center axis of the locking tab 68 and spring 70. FIG. 7 is an isolated perspective view showing the adjustment screw 64 threaded into the mounting block 34, with other components of the adjustment unit 60 omitted for purposes of illustration. FIG. 8 is an isolated perspective view similar to FIG. 7, but additionally showing the spring 70 and locking tab 68 secured to the mounting block 34 with the adjustment screw 64 (the indicator 66 and housing 62 of the adjustment unit 60 are again omitted for purposes of illustration). FIG. 9 is an isolated perspective view of the locking tab 68. FIG. 10 is an isolated perspective view similar to FIG. 8, but additionally showing the indicator 66 secured to the mounting block 34 with the adjustment screw 64 (the housing 62 is again omitted for purposes of illustration). FIG. 11 is an isolated perspective view of the indicator 66, and FIG. 12 is an isolated perspective view of the housing 62. On the basis of FIGS. 7 through 11 taken in combination with FIGS. 12 through 15, the adjustment screw 64 can be seen to include splines 64D disposed about its outer perimeter between its head 64A and threaded shank 64C. The splines 64D are adapted to engage and disengage complementary splines 68B formed throughout an inner perimeter of the locking tab 68 (FIG. 9) and complementary splines 66B on an inner perimeter of the indicator 66 at an axial end of the indicator 66 opposite the indicator markings 66A (FIG. 11). The splines 64D, 66B, and 68B are referred to as complementary in that each of the splines 66B and 68B is able to mesh with the splines 64D. As will be discussed in more detail in reference to FIGS. 13 through 15, the spring 70 is configured to urge the splines 66B and 68B of the indicator 66 and locking tab 68 into engagement with the splines 64D of the adjustment screw 64 (FIG. 13), the splines 68B of the locking tab 68 can be caused to disengage the splines 64D of the adjustment screw 64 by partially compressing the spring 70 (FIG. 14), and further compression of the spring 70 enables the splines 66B of the indicator 66 to also disengage the splines 64D of the adjustment screw 64 (FIG. 15). Though a particular configuration for the spring 70 is depicted in the drawings, various forms of biasing means are capable of providing the function of biasing the locking tab 68 and indicator 66 toward the head 64A of the adjustment screw 64, and the term “spring” is intended to encompass such alternative means. As evident from FIGS. 4 through 15, compression of the spring 70 can be achieved and the extent to which the spring 70 is compressed can be controlled by applying an axial force to the indicator 66, such as with a socket or other annular tool that is able to engage the indicator 66 independently of the adjustment screw 64.

In FIGS. 4 and 5, a scale 74 is shown as imprinted or otherwise provided on a surface of the housing 62 adjacent the perimeter of the indicator 66 and extending along at least a portion of the perimeter. More particularly, the depicted nonlimiting embodiment of the scale 74 has calibration marks that extend radially from the axis 72 and serve to represent varying amounts of movement of the adjustable gate 40. The indicator 66 includes at least one indicator mark 66A that is alignable with the calibration marks of the scale 74 by rotating the indicator 66. For example, FIG. 4 shows the indicator mark 66A as aligned with a first (“zero”) calibration mark of the scale 74, and FIG. 5 shows the indicator mark 66A as aligned with a second calibration mark of the scale 74. In the nonlimiting embodiment shown, the indicator 66 is represented as having two indicator marks 66A formed as slots that are diametrically opposite each other, such that rotation of the indicator 66 enables either of the marks 66A to be aligned with one of the calibration marks of the scale 74. The slots are represented as V-shaped so that the root of each slot creates a well-defined visual feature of the mark 66A capable of being more accurately aligned with individual calibration marks of the scale 74. As represented, a center calibration mark of the scale 74 is labeled as “zero,” and first and second sets of the calibration marks are labeled with positive and negative numbers increasing in absolute value in opposite directions from the zero calibration mark to indicate, respectively, increasing and decreasing thicknesses of slices that will be produced (assuming a righthand thread on the adjustment screw 64).

FIG. 6 shows the head 64A of the adjustment screw 64, the indicator 66, the locking tab 68, and the spring 70 as all being disposed within a bore 76 in the housing 62. FIG. 12 is an isolated perspective view of the housing 62 of the adjustment unit of FIGS. 4 through 6, and evidences that the bore 76 has a circular-shaped bore portion 76A that receives the indicator 66 and the head 64A of the adjustment screw 64, and a noncircular-shaped bore portion 76B that receives the locking tab 68 and spring 70. As shown in FIG. 12, the locking tab 68 has an outer perimeter 68A that is shaped relative to the shape of the noncircular-shaped bore portion 76B so that when the locking tab 68 is placed in the bore portion 76B, the bore portion 76B prevents the locking tab 68 from rotating about the axis 72. In the embodiment shown in FIGS. 9 and 12, the outer perimeter 68A of the locking tab 68 has a shape that is complementary to the shape of the noncircular-shaped bore portion 76B, namely, generally square-shaped, though other shapes are foreseeable, including but not limited to oval and triangular shapes, and the shapes of the outer perimeter 68A and bore portion 76B may be congruent or incongruent.

Rotation of the locking tab 68 is preferably prevented at all times while the adjustment unit 60 is fully assembled and the locking tab 68 resides within the noncircular-shaped bore portion 76B. As such, the adjustment screw 64 is not free to rotate (referred to herein as a locked rotational position) while the splines 64D of the adjustment screw 64 are engaged with the splines 68B of the locking tab 68 under the biasing effect of the spring 70, as is represented in FIGS. 6 and 13. Consequently, the locking tab 68 and spring 70 serve to automatically lock the adjustment screw 64 in a locked rotational position after an adjustment is made by simply releasing pressure on the indicator 66, through which the force required to compress the spring 70 is applied (as indicated by arrows in FIGS. 14 and 15). Simultaneously, the indicator 66 is also in a locked rotational position because it cannot be rotated due to the engagement of its splines 66B with the splines 64D of the adjustment screw 64.

In FIG. 14, the adjustment screw 64 is free to rotate out of its locked rotational position as a result of the spring 70 being sufficiently compressed a first extent to disengage the splines 68B of the locking tab 68 from the splines 64D of the adjustment screw 64. Because of the remaining engagement of their splines 66B and 64D, the adjustment screw 64 and the indicator 66 must rotate in unison with each other when the spring 70 is compressed to the extent shown in FIG. 14. As the adjustment screw 64 is rotated to adjust the gate 40 and its opening 41 to a new adjustment position, the indicator 66 rotates with the screw 64 to align the indicator mark 66A with a different calibration mark of the scale 74, and the resulting movement of the indicator mark 66A relative to the scale 74 indicates the amount of adjustment made.

By further compressing the spring 70 to a greater extent, such as shown in FIG. 15, the splines 66B of the indicator 66 can also be caused to disengage the splines 64D of the adjustment screw 64, allowing the adjustment screw 64 and the indicator 66 to rotate independently of each other. Such a capability allows for a zeroing process of the adjustment unit 60. For example, the adjustment screw 64 can be held stationary while the indicator 66 is independently rotated to align the indicator mark 66A with the zero calibration position mark or with another calibration mark of the scale 74. Alternatively, the indicator 66 can be held stationary at the zero calibration position mark (or with another calibration mark) of the scale 74 while the adjustment screw 64 is rotated to adjust the gate opening 41 to a desired setting.

In view of the above, the arrangement shown in FIGS. 4 through 15 provides for a method of adjusting the gate opening 41 of a slicing unit 26 (FIG. 6) by deflecting the trailing edge 46 of a gate 40 without using a separate tool to measure the width of the gate opening 41, and additionally provides the ability to set a “zero” calibration setting from which future adjustments can be made. Generally, three separate adjustment features are capable of being provided by the adjustment unit 60 depicted in the drawings: a slice thickness adjuster (utilizing the adjustment screw 64), a slice thickness scale (utilizing the scale 74), and a slice thickness indicator (utilizing the indicator 66 and scale 74). Moreover, the adjustment unit 60 provides the ability to accomplish the following: the adjustment screw 64 and the indicator 66 can be operated in unison while the locking tab 68 is held stationary to allow for selecting gate opening adjustments using the indicator mark 66A and scale 74 as an adjustment is made; and the adjustment screw 64 and locking tab 68 can be held stationary while the indicator 66 is rotated independent of the adjustment screw 64 to allow for zeroing of an adjustment setting. In this manner, gate openings 41 can be accurately set to obtain a desired slice thickness without the use of a separate gauge tool, the benefits of which preferably (though not necessarily) include the ability to make accurate adjustments of a gate opening 41 without the use of a separate gauge, the ability to zero a gate opening 41 to accommodate tolerance variations and wear of components, and the ability to make more rapid adjustments of a gate opening 41 with the adjustment screw 64 as the result of the ability of the locking tab 68 and spring 70 to automatically lock the adjustment screw 64 after an adjustment is made.

It should be noted that, while the automatic locking capability is desirable for eliminating the requirement for a separate locking feature to prevent the adjustment screw 64 from being rotated, in some embodiments such a feature may be unnecessary, etc., in which case the locking tab 68 could be eliminated.

While the invention has been described in terms of a particular embodiment, it should be apparent that alternatives could be adopted by one skilled in the art. For example, the machine 10, cutting head 40, impeller 14, and adjustment unit 60, and their respective components could differ in appearance and construction from the embodiments described herein and shown in the drawings, functions of certain components could be performed by components of different construction but capable of a similar (though not necessarily equivalent) function, and various materials could be used in the fabrication of the machine 10, cutting head 40, impeller 14, and adjustment unit 60, and their respective components. As such, and again as was previously noted, it should be understood that the invention is not necessarily limited to any particular embodiment described herein or illustrated in the drawings.

1. A cutting head of a cutting machine, the cutting head comprising:
a pair of mounting blocks spaced apart from each other;
a slicing unit mounted with the pair of mounting blocks, the slicing unit comprising a knife having a cutting edge configured to produce product slices;
an adjustable gate mounted with the pair of mounting blocks, the adjustable gate defining a gate opening between the cutting edge of the knife and a trailing edge of the adjustable gate, the adjustable gate being adjustable by moving the trailing edge thereof relative to the cutting edge; and
an adjustment unit comprising a housing, an adjustment screw disposed in a bore of the housing and threadably received in a threaded bore in a first mounting block of the pair of mounting blocks, a spring disposed in the bore of the housing, an indicator disposed in the bore of the housing and surrounding a head of the adjustment screw, and a scale along a perimeter of the indicator, the adjustment screw having splines and the indicator having splines that are complementary to each other, the spring being arranged within the bore of the housing so that the splines of the adjustment screw and the splines of the indicator are engaged with each other under a biasing influence of the spring and the splines of the indicator disengage from the splines of the adjustment screw by compressing the spring.

2. The cutting head of claim 1, further comprising a locking tab disposed in the bore of the housing between the spring and the indicator, the locking tab having splines that are complementary to the splines of the adjustment screw, the spring being arranged within the bore of the housing so that the splines of the adjustment screw and the splines of the locking tab are engaged with each other under the biasing influence of the spring and the splines of the locking tab disengage from the splines of the adjustment screw by compressing the spring.

3. The cutting head of claim 2, wherein the adjustment screw and the locking tab are configured so that the splines thereof disengage from each either other by compressing the spring a first extent, and the adjustment screw and the indicator are configured so that the splines thereof disengage from each either other by compressing the spring a second extent that is greater than the first extent.

4. The cutting head of claim 2, wherein the bore of the housing has a shaped portion and the locking tab has an outer perimeter that is shaped relative to the shaped portion of the bore so that the shaped portion of the bore portion prevents the locking tab from rotating within the bore.

5. The cutting head of claim 4, wherein the outer perimeter of the locking tab has a shape that is complementary to a shape of the shaped portion of the bore.

6. The cutting head of claim 1, wherein the adjustable gate is adjustable by forcibly deflecting the trailing edge thereof relative to the cutting edge of the knife.

7. The cutting head of claim 6, wherein the adjustment screw has a distal end that bears against the adjustable gate to forcibly deflect the trailing edge thereof relative to the cutting edge of the knife.

8. The cutting head of claim 7, wherein the adjustment screw is threadably received in the threaded bore in the first mounting block such that rotating the adjustment screw in first and second directions cause the distal end thereof to force the trailing edge to move inward and outward, respectively, to yield product slices that are relatively thinner and relatively thicker, respectively.

9. The cutting head of claim 1, wherein the scale has a zero calibration mark, a first set of calibration marks increasing in value in a first direction from the zero calibration mark, and a second set of calibration marks decreasing in value in an oppositely-disposed second direction from the zero calibration mark.

10. The cutting head of claim 9, wherein the indicator has at least one indicator mark adapted to be selectively alignable with the zero calibration mark, the first set of calibration marks, and the second set of calibration marks of the scale by rotating the indicator.

11. The cutting head of claim 1, wherein the housing is secured to the first mounting block with a fastener.

12. A cutting machine in which the cutting head of claim 1 is installed, the cutting machine further comprising an impeller coaxially mounted within the cutting head for rotation about an axis of the cutting head in a rotational direction relative to the cutting head, wherein the adjustable gate is adjustable by moving the trailing edge thereof radially inward and radially outward relative to the axis of the cutting head.

13. The cutting machine of claim 12, wherein the cutting machine is a centrifugal-type cutting machine.

14. A method of adjusting a gate opening of a cutting head of a cutting machine, the cutting head having a pair of mounting blocks spaced apart from each other, a slicing unit mounted with the pair of mounting blocks and comprising a knife having a cutting edge configured to produce product slices, and an adjustable gate mounted with the pair of mounting blocks, the adjustable gate defining a gate opening between the cutting edge of the knife and a trailing edge of the adjustable gate and the adjustable gate being adjustable by moving the trailing edge thereof relative to the cutting edge of the knife, the method comprising:
providing an adjustment unit associated with a first mounting block of the pair of mounting blocks, the adjustment unit comprising a housing, an adjustment screw disposed in a bore of the housing and threadably received in a threaded bore in a first mounting block of the pair of mounting blocks, a spring disposed in the bore of the housing, an indicator disposed in the bore of the housing and surrounding a head of the adjustment screw, and a scale along a perimeter of the indicator, the indicator having an indicator mark aligned with a first calibration mark of the scale, the adjustment screw having splines and the indicator having splines that are complementary to each other, the spring being arranged within the bore of the housing so that the splines of the adjustment screw and the splines of the indicator are engaged with each other under a biasing influence of the spring and the splines of the indicator disengage from the splines of the adjustment screw by compressing the spring; and then either
rotating the adjustment screw to adjust the gate opening, the indicator rotating in unison with the adjustment screw as a result of the splines of the indicator being engaged with the splines of the adjustment screw, wherein rotating the indicator aligns the indicator mark with a second calibration mark of the scale; or
compressing the spring to disengage the splines of the indicator from the splines of the adjustment screw and rotating the indicator independently of the adjustment screw to align the indicator mark with a second calibration mark of the scale.

15. The method of claim 14, wherein the adjustment unit further comprises a locking tab disposed in the bore of the housing between the spring and the indicator, the locking tab has splines that are complementary to the splines of the adjustment screw, wherein the spring is arranged within the bore of the housing so that the splines of the adjustment screw and the splines of the locking tab are engaged with each other under the biasing influence of the spring and the splines of the locking tab disengage from the splines of the adjustment screw by compressing the spring, the adjustment screw and the locking tab are configured so that the splines thereof disengage from each either other by compressing the spring a first extent, the adjustment screw and the indicator are configured so that the splines thereof disengage from each either other by compressing the spring a second extent that is greater than the first extent, and rotating the adjustment screw to adjust the gate opening comprises compressing the spring to at least the first extent to disengage the splines of the adjustment screw and the splines of the locking tab from each other.
